(19) United States
(12) Patent Application Publication
(10) Pub. No.: US 2002/0098813 A1
(43) Pub. Date: Jul. 25, 2002

(54) Apparatus and method for generating and transmitting an RF modulated signal having a modulation frequency within the AM and/or FM band

(76) Inventors: George Likourezos, Brooklyn, NY (US); Michael A. Scaturro, Garden City, NY (US)

Correspondence Address: George Likourezos, 9321 Ridge Boulevard, Brooklyn, NY, 11209, US

(21) Appl. No.: 10/015,904

(22) Filed: Nov. 1, 2001

Related U.S. Application Data
(60) Provisional application No. 60/244,856, filed on Nov. 1, 2000.

(51) Int. Cl. H04B 1/02

(52) U.S. Cl. 455/93; 455/73

(57) ABSTRACT

An apparatus is provided capable of wirelessly receiving an RF signal having a modulation frequency outside the AM and FM band and containing baseband audio content, such as Internet audio content, converting the signal to an RF modulated signal having a modulation frequency within the AM and/or FM band, and transmitting the RF modulated signal having a modulation frequency within the AM and/or FM band to a conventional AM/FM radio or stereo equipment to audibly reproduce the baseband audio content. The apparatus is also capable of receiving a hardwired signal including audio content, such as an Internet audio signal, modulate the audio content to an RF modulated signal having a modulation frequency within the AM and/or FM band, and transmitting the RF modulated signal to a conventional AM/FM radio or stereo equipment to audibly reproduce the audio content.

### PRIORITY

This application claims priority to a U.S. Provisional Application filed on Nov. 1, 2000 and having U.S. Provisional Application Serial No. 60/244,856, the contents of which are hereby incorporated by reference.

### BACKGROUND OF THE INVENTION

1. Field of the Invention

The present invention is an apparatus capable of demodulating a carrier signal having a modulation frequency outside the AM or FM band and including audio content, to a signal having a modulation frequency within the AM and/or FM band for reproduction of the audio content by a conventional AM/FM radio or stereo equipment.

2. Description of the Related Art

Among the many services provided by web sites accessible via the Internet is the delivery of streaming and non-streaming audio content. Web sites which provide this service are referred to as Internet radio stations. For example, the web sites MSNBC.com and CNN.com offer the option of listening to streaming or non-streaming audio content corresponding to audio content broadcast by the cable news shows MSNBC and CNN. It is estimated that there are more than 1,000 Internet radio stations in existence and Internet radio usage is increasing at an enormous rate.

One reason for the tremendous increase in Internet radio usage is the ability to listen to audio content being broadcast or transmitted from a location which is out of range for reception by a conventional radio. For example, someone living in New York City can listen to streaming or non-streaming audio content which is being transmitted via the Internet from Athens, Greece. Another reason for the surge in popularity is the ability to listen to specific audio content based on, for example, genre: alternative, blues, pop, classic, country, news, weather, sports, oldies, etc.; language: English, Spanish, Hebrew, French, Italian, Chinese, Russian, Japanese, Greek, etc.; and region: North America, Latin America, South America, Australia, Europe, Asia Pacific, Africa, Middle East, etc.

Generally, in order to listen to streaming or non-streaming audio content transmitted over the Internet, one must use a browser to access a web site offering the streaming or non-streaming audio content, click an appropriate button or icon to start transmission of the streaming or non-streaming audio content, and be within earshot of the computer terminal's speakers. Hence, one must generally have access to a computer terminal having at least one speaker and browser, and be an Internet subscriber.

Internet radio systems also exist for listening to streaming or non-streaming audio content transmitted over the Internet without having to be within earshot of the computer terminal's speakers. These Internet radio systems are typically configured to connect to the computer terminal or a broadband network, receive streaming or non-streaming audio content transmitted via the Internet, convert the streaming or non-streaming audio content to an FM signal having a predetermined frequency, and transmit the FM signal via a transmitter to an FM receiver, such as a conventional radio, tuned to the predetermined frequency and located within a predetermined distance, e.g., within 1000 feet, from the transmitter. Some systems even require the FM receiver to be located along a direct line-of-sight path from the transmitter. Such Internet radio systems give one the freedom to move around the house or workplace, i.e., not to be confined within earshot of the computer terminal's speakers, and still listen to Internet audio content piped from the conventional radio's speakers rather than the computer terminal's speakers.

While these systems extend the listening range beyond earshot of a computer terminal's speakers, they confine the listener to a predetermined listening range. That is, if the listener travels outside a pre-set radius, e.g., outside the predetermined range (e.g., 1000 feet), the listener will not be able to listen to the streaming or non-streaming audio content. Another disadvantage for several of these systems is that many locations do not have access to a broadband network or other high-data rate, hardwired communication networks, e.g., most homes and businesses.

However, even locations that do have access to such networks, such as office buildings, airports, and institutions of higher learning, “force” the listener to remain close to the conventional radio, or other standalone device capable of playing back streaming or non-streaming audio content after being connected to a broadband network, and not to increase the volume of the radio for fear of disturbing others.

If the listener uses a battery-operated radio to receive the FM signal containing the audio content and to playback the audio content, the listener is still “forced” to remain within the predetermined locale. That is because the FM signal being transmitted by the transmitter of the Internet radio system would be significantly weaker beyond the predetermined locale for adequate reception by the receiver of the battery-operated radio.

A need therefore exists for an apparatus capable of playing back audio content transmitted via a network, such as the Internet, which does not confine the listener to a predetermined locale or listening range. A need also exists for an apparatus capable of converting an RF modulated signal including baseband audio content and having a modulation frequency outside the AM and FM band to an RF modulated signal having a modulation frequency within the AM and/or FM band, and transmitting the RF modulated signal to a conventional AM/FM radio or stereo equipment to audibly reproduce the baseband audio content, where the listener is not confined or restricted to a predetermined locale.

### SUMMARY OF THE INVENTION

It is therefore an object of the present invention to provide an apparatus capable of converting an RF modulated signal including baseband audio content transmitted via at least one network, such as the Internet, Wireless Local Area Network (WLAN), cellular communications network paging network, etc., to an RF modulated signal having a modulation frequency within the AM and/or FM band, and transmitting the RF modulated signal to a conventional AM/FM radio or stereo equipment to audibly reproduce the baseband audio content, where a listener is not confined or restricted to a predetermined locale for listening to the baseband audio content.

Accordingly, in one embodiment of the present invention, an apparatus is provided capable of wirelessly receiving an RF modulated signal having a modulation frequency outside the AM and FM band and including baseband audio content, such as Internet audio content, converting the modulated signal to an RF modulated signal having a modulation frequency within the AM and/or FM band, and transmitting the RF modulated signal to a conventional AM/FM radio or stereo equipment to audibly reproduce the baseband audio content. The apparatus can be battery powered and the conventional AM/FM radio can be any device which enables the listener to be mobile.

The RF modulated signal having a modulation frequency outside the AM and FM band is received by the apparatus by wireless means using a reception interface. The modulated signal may be, for example, transmitted by a satellite, cellular, paging or other wireless communications network or system, such as WLAN. The reception interface is preferably within the apparatus and may be any combination of hardware and/or software.

It is also provided that the apparatus includes a first input port and Internet/network connection hardware and/or software, i.e., a web browser, for connecting the apparatus directly to the Internet or other network transmitting audio content via a non-wireless (i.e., hardwired) communications network, such as a WAN, LAN, PSTN or broadband network. Accordingly, the apparatus can receive a hardwired data stream including audio content, such as a streaming or a non-streaming audio signal, transmitted over the Internet or other network, modulate the audio content to an RF modulated signal having a modulation frequency within the AM and/or FM band, and transmit the RF modulated signal to a conventional AM/FM radio or stereo equipment to audibly reproduce the audio content.

The apparatus also includes a second input port to provide a hardwire interface to a personal computer or a network appliance, such as an Internet phone, which has access to the Internet or other network for receiving a data stream including audio content. Accordingly, the apparatus of the present invention is capable of being directly connected via a hardwired connection to a communications network, a personal computer, or a network appliance for receiving a data stream including audio content, modulating the audio content to an RF modulated signal having a modulation frequency within the AM and/or FM band, and wirelessly transmitting the RF modulated signal to a conventional AM/FM radio or stereo equipment to audibly reproduce the audio content. It is contemplated that a single input port can be provided to the apparatus for performing the functions of the first and second input ports.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of the apparatus according to the present invention;

FIG. 2 is a block diagram of the circuitry of the apparatus according to the present invention; and

FIG. 3 is a perspective view of an alternate embodiment where the apparatus is built-in or integrated with an AM/FM radio.

### DETAILED DESCRIPTION OF THE INVENTION

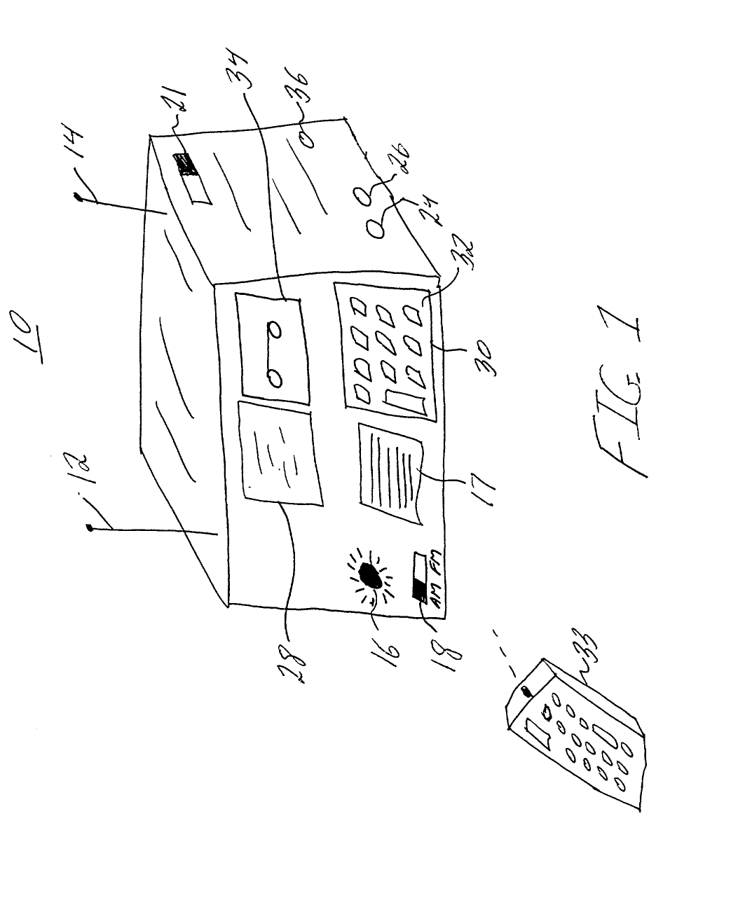

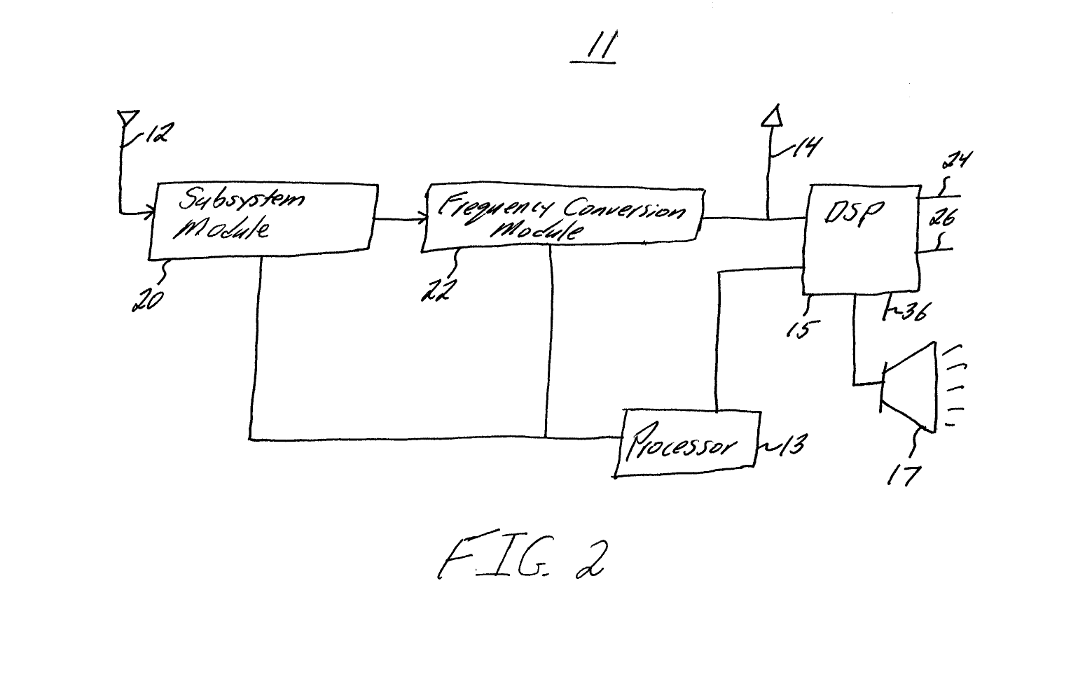

With reference to FIGS. 1 and 2, there are shown a perspective view and a block diagram, respectively, of one embodiment of the apparatus of the present invention designated generally by reference numeral 10. The apparatus 10 includes circuitry 11 having a processor 13 capable of executing programmable or embedded instructions for operating the apparatus 10 in one of two modes, i.e., a wireless operational mode and a non-wireless operational mode, and for performing other functions as described herein.

### Wireless Operational Mode

In the wireless operational mode, the apparatus 10 wirelessly receives an RF modulated signal including baseband audio content, such as Internet audio content, converts the modulated signal to an RF modulated signal having a modulation frequency within the AM and/or FM band, and transmits the RF modulated signal to a conventional AM/FM radio or stereo equipment to audibly reproduce the baseband audio content.

In the wireless operational mode, the apparatus 10 is preferably operated using battery power to make the apparatus 10 mobile. Additionally, in the wireless operational mode, the conventional AM/FM radio is preferably a vehicle radio, a radio powered by battery power, or other mobile radio not confined to a certain locale to enable the listener to move about. Also, it is contemplated that the apparatus 10 can be fitted with a solar power system in order for the apparatus 10 to be powered by solar power.

Accordingly, in the wireless operational mode, the user can listen to audio information transmitted over the Internet while traveling or outside of the home by attaching the apparatus 10 to a portable AM/FM radio. The apparatus 10 can also be simply placed in a user's briefcase, pant's pocket, etc. or attached to the user's belt in close proximity to the portable AM/FM radio. It is also envisioned to place the apparatus 10 inside or outside a vehicle in order for a driver to be able to listen to audio content transmitted over the Internet or other network via the vehicle's AM/FM radio. Therefore, the inventive apparatus 10 can make any standard AM/FM radio or stereo equipment play audio content transmitted over the Internet or other communications network.

The RF modulated signal is received by a reception antenna 12 of the apparatus 10 via a wireless connection between the apparatus 10 and a satellite, cellular, paging or other wireless communications network or system, such as WLAN, capable of transmitting the modulated signal to the apparatus 10. The wireless connection is effected by communications hardware and/or software (not shown) as known by one ordinarily skilled in the art. The communications hardware and/or software is either interfaced to the apparatus 10 or integrated, i.e., embedded, within the apparatus 10.

The RF modulated signal includes baseband audio content, such as Internet audio content. Modulation techniques are well known in the art and any such modulation technique presently used or envisioned may be used to modulate the baseband information signal before wirelessly transmitting the signal to the inventive apparatus 10.

The apparatus 10 includes a subsystem module 20 (see FIG. 2) for stripping a carrier signal modulated with the baseband information signal, a frequency conversion module 22 (see FIG. 2) for converting the baseband information signal to an RF modulated signal having a modulation frequency within the AM and/or FM band. The received signal is converted to a signal having a specific modulation frequency within the AM and/or FM band according to a frequency setting of a frequency tuning dial 16 and an AM/FM selection switch 18. The frequency tuning dial 16 and the AM/FM selection switch 18 control conventional frequency-setting circuitry and AM/FM reception circuitry within the apparatus 10 in a similar manner as performed in conventional AM/FM radio or stereo equipment.

The RF modulated signal having a modulation frequency within the AM and/or FM band is then transmitted via a transmission antenna 14 to the AM/FM radio or stereo equipment for audible reproduction of the audio content. The audio content is audibly reproduced only if the AM/FM radio or stereo equipment is tuned to the same or approximate frequency as the RF modulated signal. It is contemplated that a single antenna can be used for performing the functions of both the reception antenna 12 and the transmission antenna 14.

FIG. 2 is a block diagram illustrating the operation of the apparatus 10 in the wireless operational mode. The wirelessly transmitted signal is received by the reception antenna 12 and sent to the apparatus' subsystem module 20 for stripping the carrier of the received signal. The demodulated signal is then sent to the frequency conversion module 22 for modulating the baseband signal to an RF modulated signal having a modulation frequency within the AM and/or FM band. The RF modulated signal is then transmitted by the transmission antenna 14 to an AM/FM radio or stereo equipment.

The signal received by the reception antenna 12 can also be processed by conventional circuitry, such as digital signal processing (DSP) circuitry 15, within the apparatus 10 and the signal's audio content can be played over a speaker 17 of the apparatus 10 without converting the received signal to an RF modulated signal having a modulation frequency within the AM and/or FM band. A switch 21 on the apparatus controls whether the audio content is to be played by the external AM/FM radio or stereo equipment, or by the speaker 17.

### Non-wireless Operational Mode

For operating the apparatus 10 in the non-wireless operational mode, the apparatus 10 includes a first input port 24 and Internet/network connection hardware and/or software, i.e., a web browser, for directly connecting the apparatus 10 to the Internet or other network transmitting audio content via a non-wireless communications network, such as a WAN, LAN, PSTN or broadband network. Accordingly, the apparatus 10 can non-wirelessly receive a hardwired data stream including audio content, such as streaming and non-streaming audio signals, transmitted over the Internet or other network, modulate the audio content to an RF modulated signal having a modulation frequency within the AM and/or FM band, and transmit the RF modulated signal using the transmission antenna 14 to a conventional AM/FM radio or stereo equipment to audibly reproduce the audio content.

The apparatus 10 also includes a second input port 26 to provide a hardwire interface to a personal computer or a network appliance, such as an Internet phone, which has access to the Internet or other network for receiving a data stream including audio content. Accordingly, the apparatus 10 of the present invention is capable of being directly connected via a hardwired connection to a communications network, a personal computer, or a network appliance for receiving a data stream including audio content, modulating the received audio content to an RF modulated signal having a modulation frequency within the AM and/or FM band, and wirelessly transmitting the RF modulated signal using the transmission antenna 14 to a conventional AM/FM radio or stereo equipment to audibly reproduce the audio content. It is contemplated that a single input port can be provided to the apparatus 10 for performing the functions of the first and second input ports 24, 26.

The apparatus 10 receives the hardwired audio content via one of the described input ports 24, 26 using a connection jack or cable and delivers the audio content to processing circuitry 15 within the apparatus 10 for processing. It is provided that the apparatus 10 includes at least one switch for switching the apparatus 10 from the wireless operational mode to the non-wireless operational mode.

The processing circuitry 15 processes the received hardwired signals using conventional audio processing techniques to modulate the audio content to an RF modulated signal having a modulation frequency within the AM and/or FM band. The frequency is selected by a user using the frequency tuning dial 16 on the apparatus 10. As with the wireless operational mode, the frequency selected should be a frequency within the AM and/or FM band suitable for clear reception by an AM/FM radio or stereo equipment in close proximity to the apparatus 10.

For example, if the frequency tuning dial 16 is used to select 102 Hz on the FM band, the audio content is modulated to an RF modulated signal having a frequency of 102 Hz at a power level capable of overriding any existing signals being simultaneously received by the AM/FM radio or stereo equipment at the selected frequency, or 102 Hz. If, however, the existing signals which are simultaneously being received by the AM/FM radio or stereo equipment cannot be satisfactorily overridden by selecting 102 Hz using the frequency tuning dial 16, then the frequency tuning dial 16 can be used to select another frequency. The newly selected frequency is preferably a frequency which provides a more optimum reception by the AM/FM radio or stereo equipment of the AM/FM signal generated by the apparatus 10 and transmitted by the transmission antenna 14, if the AM/FM radio or stereo equipment is tuned to that frequency.

Upon being received by the AM/FM radio or stereo equipment, the RF modulated signal having a modulation frequency within the AM and/or FM band is processed in a conventional manner for audio playback.

It is contemplated to include circuitry within the apparatus 10 as known by one skilled in the art to configure the apparatus 10 for receiving MP3 files and/or other digital files via the first and second input ports 24, 26, for converting the same to an RF modulated signal having a modulation frequency within the AM and/or FM band, and transmitting the RF modulated signal to an AM/FM radio or stereo equipment for playback.

The apparatus 10 also includes an output data port 36 connected to processing circuitry for connecting the apparatus 10 directly to an input port of the AM/FM radio or stereo equipment, or a computing device, such as a PDA, personal computer, laptop, cellular phone, etc. Hence, the apparatus 10 can process the data stream received by the input ports 24, 26 and directly transmit the processed data stream to the AM/FM radio or stereo equipment, or a local computing device, in a format suitable for audible reproduction by the AM/FM radio or stereo equipment, or the local computing device. The format can be, e.g., an audio data format analogous to an audio data format of audio content stored by a compact-disc or other storage medium/device.

It is contemplated that the local computing device can be used to process and transmit, either wirelessly or non-wirelessly, the data stream received via the output data port 36 to a remote computing device for audible reproduction of the audio content. It is further contemplated to equip the apparatus 10 with a modem or other communications hardware/software to generate and wirelessly transmit signals representative of the received data stream to the remote computing device without having to process and transmit the data stream to the local computing device.

When being operated in the non-wireless operational mode, the apparatus 10 can be powered by plugging the apparatus 10 to an electrical wall outlet using an electrical cord to preserve battery power.

### Additional Features of the Apparatus

Additional features of the apparatus 10 will now be described which can be used while operating the apparatus 10 in the wireless or non-wireless operational modes. One main feature of the apparatus 10 is a display 28 for displaying various information, such as the AM and/or FM frequency selected by the frequency tuning dial 16; the Internet radio station and/or URL whose signal/data stream is currently being received by the apparatus 10 and being converted to an RF modulation signal having a modulation frequency within the AM and/or FM band and/or being played back via the speaker 17; video corresponding to an Internet radio station and/or URL; a listing of each Internet radio station or URL which has been pre-programmed within the apparatus 10 for quick selection; information relating to each listed Internet radio station and URL, e.g., the type and language of the audio content transmitted by the listed Internet radio stations and URLs; information relating to the Internet radio station or URL corresponding to the signal/data stream currently being received by the apparatus 10; the current date and time; a user-generated programming schedule, e.g., a customized playlist, containing at least one Internet radio station and/or URL whose audio content is desired by the user to be heard at a specific time period in the future; etc.

The user-generated programming schedule is generated by connecting the apparatus 10 via the first or second input ports 24, 26 to a computer or other programming device having programming capabilities, such as programming software, for generating and sending the programming schedules to the apparatus 10 for storage. It is contemplated that the computer or other programming device can also be used to control other features of the apparatus 10 described herein.

The user-generated programming schedule can also be generated by remotely accessing the apparatus 10 either wirelessly or non-wirelessly via a network, such as the Internet, using a computer or programming device having programming capabilities for generating and sending the programming schedule to the apparatus 10 for storage. The programming schedule can also be generated by connecting the apparatus 10 to a keyboard and using the keyboard to select, either by typing or scrolling along the displayed Internet radio station and URL listings, at least one Internet radio station and/or URL, and at least one beginning and at least one ending time for the at least one selected Internet radio station and/or URL. The programming schedule is preferably stored within a memory of the processor 13.

Alternatively, the programming schedule can be generated by using a timer or control panel 30 on the apparatus 10. The control panel 30 can be used to program the apparatus 10 to power on/off at specific times in the future and to receive signals corresponding to at least one specific Internet radio station and/or URL. In this case, alphanumeric and other keys 32 of the control panel 30 are used to enter at least one pair of on/off times and at least one Internet radio station and/or URL for generating the programming schedule. When the programming schedule is generated, a key, such as the “ENTER” key, is pressed to store the programming schedule within the processor 13.

For example, the apparatus 10 can be programmed using the control panel 30 to power on at 7:00 am for receiving an RF modulated signal having a modulation frequency outside the AM and FM band and corresponding to CNN.com, converting the received signal to an RF modulated signal having a modulation frequency within the AM and/or FM band, and transmitting the converted signal to an AM/FM radio or stereo equipment, and to power off at 9:00 am. It is provided that the processor 13 has an internal clock for keeping track of the current time. Accordingly, when the internal clock reaches the pre-programmed on/off times corresponding to the programming schedule, the processor 13 powers the apparatus 10 on/off (or stores the audio content for playback later on in the future).

It is contemplated that the display 28 can be used in conjunction with the control panel 30 for generating the programming schedule. That is, at least one key of the control panel 30 can be used to scroll the Internet radio station and URL listings shown on the display 28 and select the at least one Internet radio station and/or URL by highlighting the selected item and pressing a key, such as the “ENTER” key. It is further contemplated that the display 28 is a touch-screen display for ease of use. Further, it is contemplated that the control panel 30 is integrated with the touch-screen display 28, i.e., the control panel 30 is part of the touch-screen display.

The control panel 30 in conjunction with the display 28 can be used to operate the apparatus 10 as an Internet appliance for performing various Internet-related tasks, such as sending/receiving e-mail, searching the Internet using search words via a search engine operated by the apparatus 10, checking stock quotes, accessing web sites by entering specific URLs, etc. The control panel 30 can also be used to type-in specific Internet radio stations and web sites and store them within the processor 13, such that these Internet radio stations and web sites can be listed on the display 28 in the future for quick selection.

It is provided that the processor 13 of the apparatus 10 and/or the DSP circuitry 15 is capable of translating the on/off times and Internet radio stations/URLs of the user-generated programming schedule to audio signals. The audio signals can then be transmitted to the speaker 17 of the apparatus 10 for audible reproduction, in order for the user to audibly hear the on/off times and Internet radio stations/URLs of the user-generated programming schedule. Accordingly, a user can audibly check if the user-generated programming schedule was properly generated and if it conforms to his liking. If not, the user can modify the programming schedule using one of the methods for generating the programming schedule described above.

The apparatus 10 further includes remote control capabilities for operating the apparatus using a remote control device 33. For instance, if a particular number is pressed on the device 33, the apparatus 10 switches from receiving and converting an RF modulated signal (wireless operational mode) or hardwired signal (non-wireless operational mode) to receiving and converting another RF modulated signal or hardwired signal corresponding to the preset.

For example, if a user presses the number 10 on the remote control device 33, the apparatus 10 associates the number 10 to CNN.com using a look-up table or other database stored in a memory therein, as known in the art, and, in the case of a wireless connection, the apparatus 10 converts the incoming signal corresponding to CNN.com to an RF modulated signal having a modulation frequency within the AM and/or FM band. In the case of a hardwired connection, the apparatus 10 connects via the Internet, or other network, to at least one server to receive a data stream including audio content corresponding to the URL www.CNN.com, and modulates the audio content to an RF modulated signal having a modulation frequency within the AM and/or FM band.

In either case, by entering a number other than 10 on the remote control device 33, the AM/FM radio or stereo equipment in proximity to the apparatus 10 (or the speaker 17 of the apparatus 10) stops playing audio content corresponding to CNN.com and starts to play audio content corresponding to the newly entered preset on the remote control device 33. A similar remote control operation is involved by remotely accessing via a network and controlling the apparatus 10 by a computing device, such as a PDA, personal computer, laptop, cellular phone, etc. In this case, the computing device becomes the remote control device.

The remote control device 33 can also be used for controlling other functions of the apparatus, such as switching between AM and FM, controlling the volume of the speaker 17, etc.

The apparatus 10 also includes recording means 34 for recording audio content, e.g., audio content transmitted over the Internet, for playback at a future time. The recorded audio content can be audibly reproduced at a future time either internally by the speaker 17, or externally by modulating the stored audio content to an RF modulated signal having a modulation frequency within the AM and/or FM band, and transmitting the RF modulated signal having a modulation frequency within the AM and/or FM band to an AM/FM radio or stereo equipment, as described above.

It is contemplated to provide the apparatus 10 with optical-to-RF conversion and transmission circuitry, as known in the art, for converting transmitted audio received as an optically encoded signal including audio content into an RF modulated signal having a modulation frequency within the AM and/or FM band capable of reception by the AM/FM radio and stereo equipment. The optical-to-RF conversion and transmission circuitry will then transmit the RF modulated signal to the AM/FM radio or stereo equipment, or a remote computing device for audible reproduction, as described above.

Preferably, the apparatus 10 of the present invention has a size about the size of a conventional beeper, in order to make the apparatus 10 highly mobile. Further, the apparatus 10 is constructed from hard plastics to make it durable and weather-resistant.

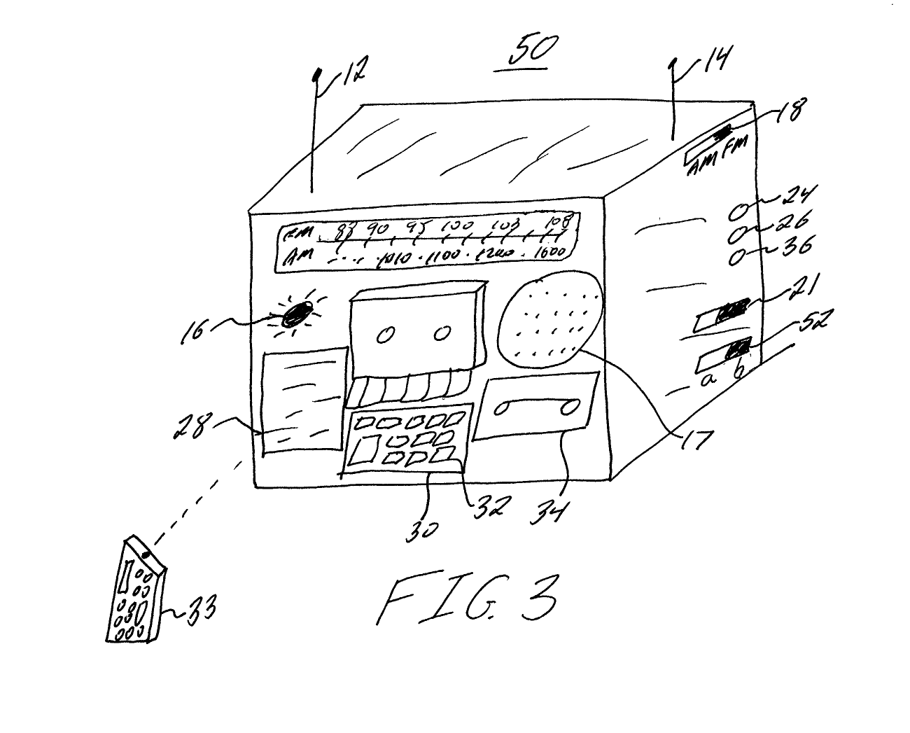

In an alternate embodiment as shown by FIG. 3, the apparatus 10 is built or integrated within an AM/FM radio to provide an Internet radio device 50 having the ability to receive RF modulated signals or hardwired signals, e.g., a data stream, including audio content, such as Internet audio content, convert the received signals to an RF modulated signal having a modulation frequency within the AM and/or FM band, and audibly play the audio content transmitted over the Internet via the integral AM/FM radio. In this embodiment, the generated RF modulated signal having a modulation frequency within the AM and/or FM band and transmitted by the transmission antenna 14 is picked up by the reception antenna 12. Hence, the reception antenna 12 performs the function of receiving RF modulated signals having a modulation frequency outside the AM and FM band, and also performs the function of receiving modulated audio signals having a modulation frequency within the AM and/or FM band. A switch 52 on the device 50 is used to switch between the two alternate types of operation.

Although various embodiments of the present invention have been described herein in detail, it will be appreciated by those skilled in the art, that variations may be made thereto without departing from the spirit of the invention or the scope of the appended claims.

What is claimed is:

1. An apparatus comprising:
means for receiving an RF modulated signal having a modulation frequency outside the AM and FM band and containing baseband audio content;
means for converting the received RF modulated signal into an RF modulated signal having a modulation frequency within the AM and/or FM band; and
means for transmitting the RF modulated signal having a modulation frequency within the AM and/or FM band to an audio reproduction apparatus for audibly reproducing the baseband audio content.

2. The apparatus according to claim 1, wherein the baseband audio content is Internet audio content.
